(19) United States
(12) Patent Application Publication
(10) Pub. No.: US 2005/0278370 A1
(43) Pub. Date: Dec. 15, 2005

(54) System and method for information storage

(76) Inventor: Chris Zegelin, San Jose, CA (US)

Correspondence Address: BAKER & BOTTS, 30 ROCKEFELLER PLAZA, NEW YORK, NY, 10112, US

(21) Appl. No.: 10/834,653

(22) Filed: Apr. 29, 2004

(51) Int. Cl. G06F 17/30

(52) U.S. Cl. 707/102

(57) ABSTRACT

A method for providing information concerning an item includes attaching to the item an information button containing data identifying the item. An identifying location system transmitter is also provided on the item. The information button is read and the data identifying the item is stored on a computer, associated with data identifying the location system transmitter. A location system is used to locate the item by transmissions from the identifying location system transmitter. The data identifying the item is retrieved from the computer using the location system transmitter identifying data.

### BACKGROUND OF THE INVENTION

The present invention relates to information and retrieval systems, and also to systems for locating items. In particular the method and system of the invention is an improvement in the use of information buttons.

Information buttons are electronic devices which can store up to about 2K of data and which can be read using a contact reading device, which must be placed in contact with the information button to accomplish the reading function. Likewise information can be written to the device using a writing device, again by placing the writing device in contact with the button. Information buttons are available from Dallas Semiconductor and are described at www.ibutton.com.

Information buttons can be used to store information concerning the contents of packages or crates that have a large and varied number of items shipped together. In addition to identification of the items, the buttons can store information regarding the source, the date of manufacture, size and quantity information. Instructions concerning use, shipment and storage may also be included.

The use of mobile data communications systems to perform location functions for locating mobile units is described in articles entitled Enhancements to the User Location and Tracking System, by Paramvir Bahl and Venkata N. Padmanabhan, and User Location and Tracking in an In-Building Radio Network, Microsoft Technical Report MSR-TR-99-12, dated February 1999, by the same authors, both published by Microsoft Research. As described therein, signal strength of signals of the wireless data communications system, such as a system using the protocol of IEEE Standard 802.11, are used for locating mobile units within an area serviced by the system. Other techniques for locating mobile units using the wireless data communications systems or other location system are possible.

For example, in co-pending application Ser. No. 09/528,697, filed Mar. 17, 2000, which is owned by the assignee of the present application and incorporated herein by reference, there is described a system which follows the protocol of IEEE Standard 802.11, but which uses a combination of RF Ports and Cell Controllers to perform the functions of Access Points of a classical 802.11 data communications system. Lower level MAC functions are performed by the RF Ports and higher level MAC functions, including association and roaming functions, are performed by the cell controller. The term “access point” as used herein is intended to include conventional access points, such as those which follow the protocol of IEEE Standard 802.11 and perform all MAC functions, as well as RF Ports operating with cell controllers, as described in the incorporated co-pending application.

It is an object of the present invention to provide a system and method for coordinating information concerning an item which is stored on an information button attached to the item with information concerning the location of the item as determined by an item locating system.

### SUMMARY OF THE INVENTION

In accordance with the invention there is provided an electronic device for locating and identifying an item. The device includes an information button having a memory arranged to receive and store data, the data including data identifying an item to which the electronic device is attached. The information button is arranged to provide the data to a contact reading device. The device includes an identifying location system transmitter, arranged to transmit signals identifying the transmitter for use in locating the item to which the electronic device is attached using a location system and, to selectively transmit additional data. A control unit is arranged to selectively transfer data from the information button to the identifying location system transmitter and to cause the transmitter to transmit the transferred data.

The control unit may be arranged to selectively transfer data representing an exception event for the information button, such as an event of reading data from the information button, writing data to the information button, tampering with the information button or a failing battery. Further the control unit may be arranged to transfer selected data stored in the information button memory.

In accordance with the invention there is provided a method for providing information concerning an item. An information button is provided on the item, the information button contains data relating to the item. An identifying location system transmitter is also provided on the item. The information button is read and the data contained thereon is stored in a computer associated with data identifying the location system transmitter. A location system is used to locate the item. Data is retrieved from the computer using the location system transmitter identifying data.

The location transmitter may include the data identifying the location system transmitter as a bar code on the transmitter and the bar code may be read to obtain the data identifying the location system transmitter.

In accordance with the invention there is provided a method for providing information concerning location of an item. An information button is provided on the item, the information button containing data relating to the item. An identifying location system transmitter is also provided on the item. The information button is read and the data recorded thereon is stored in a computer associated with data identifying the location system transmitter. A location system is used to locate the item and data representing location of the item in the computer. Data identifying the location system transmitter is retrieved by correlating data concerning a desired item with the stored data from the information button to retrieve the associated data identifying said location system transmitter. The data representing location of the item is retrieved from the computer using the location system transmitter identifying data.

In accordance with the invention there is provided a method for monitoring an information button device. A monitoring computer is provided and connected to receive data from a location system. An information button is provided having an identifying location system transmitter. The location system transmitter is used to signal to the monitoring computer that an exception event has occurred for the information button.

The location system transmitter may signal the monitoring computer when the information button is read, written to, when a battery is failing or when the information button is tampered with.

In accordance with the invention there is provided a method for transferring data from an information button device to a computer. A location system transmitter is connected to receive data stored in a memory of the information button, and arranged to communicate with a location system having a computer. Selected data is transferred from the information button memory to the transmitter and transmitted to the computer.

The data may be periodically transferred to the transmitter in cyclical increments. Alternately, a receiver may be provided for receiving command signals and the selected data is transferred to the transmitter in response to command signals.

For a better understanding of the present invention, together with other and further objects thereof, reference is made to the following description, taken in conjunction with the accompanying drawings, and its scope will be pointed out in the appended claims.

### BRIEF DESCRIPTION OF THE DRAWINGS

FIG. 1 is a schematic representation of a system in accordance with the present invention.

FIG. 2 is a perspective view of an electronic device in accordance with an embodiment of the invention.

FIG. 3 is a block diagram of the device of FIG. 2.

### DESCRIPTION OF THE INVENTION

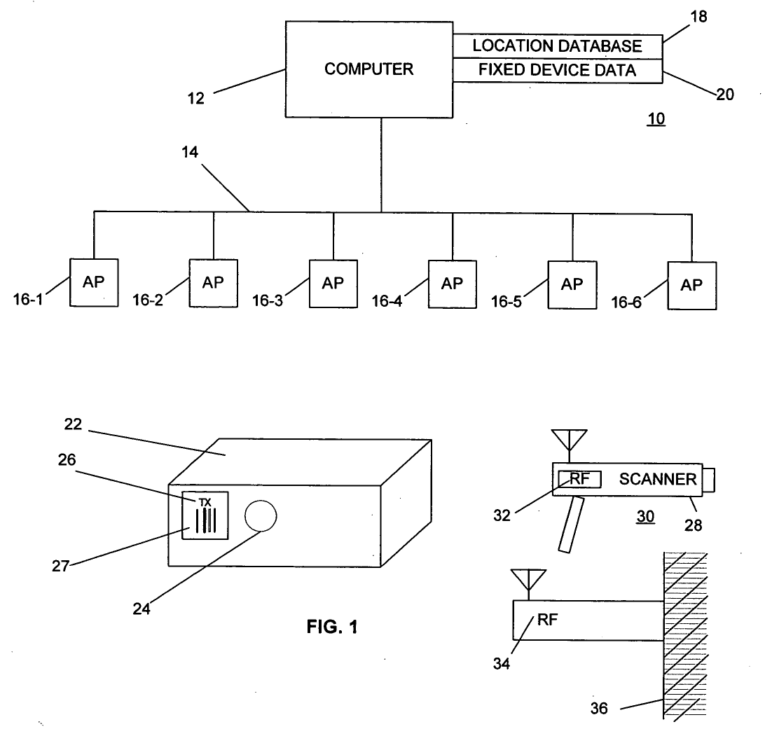

Referring to FIG. 1 there is shown an exemplary system 10 for practicing the method of the present invention. The system is useful in warehouses, shipping depots, and the like. The system includes a computer 12 which is connected over a wired network 14 to a plurality of access points 16-1 to 16-6 by which wireless data communications with mobile units can be conducted. The access points are collectively referred to by reference numeral 16. In addition to providing mobile data communications the system of FIG. 1 also includes provisions for locating mobile units, such as mobile unit 30, and other devices, such as location transmitter 26. Location can be provided using a data communications network, such as an 802.11 network as described in the referenced articles. The location may be determined, for example, by measuring the signal strength for transmissions between a mobile unit and a plurality of access points and comparing the measured signal strength to a database 18 relating signal strength to location.

As stated above information buttons can be used to provide a significant amount of data regarding an item to which the information button is attached. The problem is that in order to view such information the user must bring an information button reader into contact with the button, and therefore must be in the same location as the item.

Information buttons can be provided on an item by a manufacturer to identify contents of a shipping crate, or to identify shipping instructions. The information button can thereby take the place of a shipping document or bill of lading, and enable the information thereon to be computer read. The information button cannot, however be used to locate the item, since reading the information stored thereon requires contact therewith.

In accordance with one embodiment of the invention an item, such as a package 22 or piece of equipment is provided with an information button 24 and additionally provided with a location system transmitter 26, which may be a transmitter operating according to a communications protocol, such as IEEE Standard 802.11, or an RFID tag, or some other type of transmitter which may be utilized for location purposes. Advantageously the transmitter 26 may include a bar code 27, which can be read to identify the transmitter.

In one embodiment of the invention, the information button may be provided by a manufacturer to identify the contents of a package and other information concerning the contents. Shipping data may also be provided on the information button for use in transport of the package from the manufacturer, via shipping companies, distributors, warehouses and the like. The transmitter 26, can be added after the package leaves the manufacturer and be designed to be compatible with the system being used by an end user or a warehouse during storage of the package, for assistance in locating the package 22 and the items contained therein. For example, an end user may receive the package after shipment and determine the contents thereof by reading the information button with a mobile unit 30 having a button reader 28. At this time a transmitter 26 is attached to the package 22 for subsequent use in locating the package. The receiving clerk reads the bar code 27 on the transmitter 26, which identifies the individual transmitter and the data is associated with the data read from information button 24. The associated data is transferred to a computer, such as by using WLAN communications, from RF unit 32 of mobile unit 30 to one of access points 16 and thereafter to computer 12. Computer 12 then makes an entry into item database 20 which enables correlation of the identification of transmitter 26, read from bar code 27, with the data read from information button 24, and enables retrieval of the associated data using either entry of data corresponding to the transmitter identity or the information button data.

Following initial entry of the data into the computer, the location system tracks the location of the transmitter 26 and consequently the package or other item 22 to which it is fixed. Location data is stored in location database 18 correlated to the identification of the transmitter. A person who needs to locate an item within package 22 can access computer 12 and inquire about a particular item which is needed. By accessing the database 20, the computer 12 can ascertain the that the required item is within a particular package and determine the identity of the transmitter 26 attached to the package. By referring to location database 18 the computer can determine the current location of the package having the needed item and provide the information to the requesting person.

Likewise the contents of a package can be determined, for example by scanning the bar code on transmitter 26 to determine its identification data. Using a mobile unit 30, a person can retrieve from computer 12 the information previously read from the information button, which is possibly updated to reflect items removed from the package.

The system of the invention can facilitate inventory management, since there is no need to record the location of a package, and location information does not need to be entered each time an item moves. Further in connection with a manufacturing operation the location of an item, correlated with information about the item, can be constantly tracked. For example, in automobile manufacturing where vehicles are ordered with special equipment, and the specification for the vehicle equipment is provided on an information button attached to the vehicle, the computer 12 can track progress of the vehicle and take measures to assure that the needed special equipment is at an assembly station when the vehicle arrives at the station.

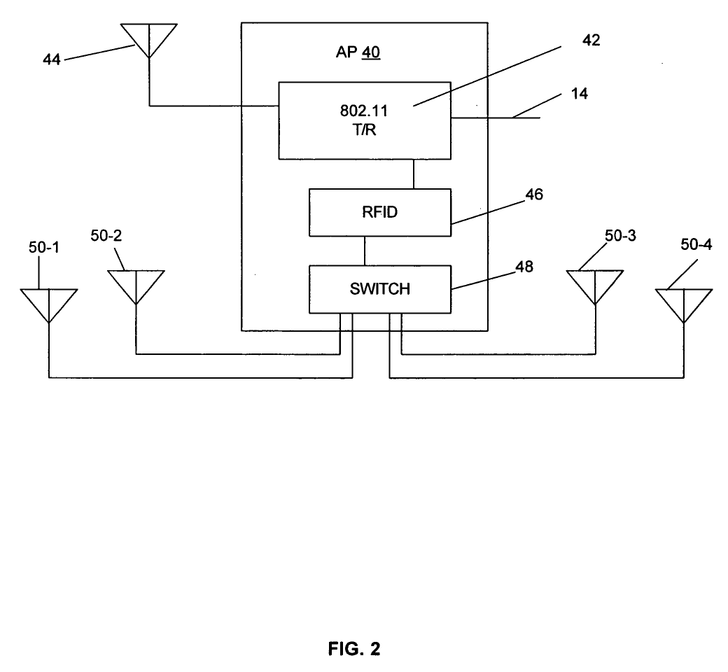

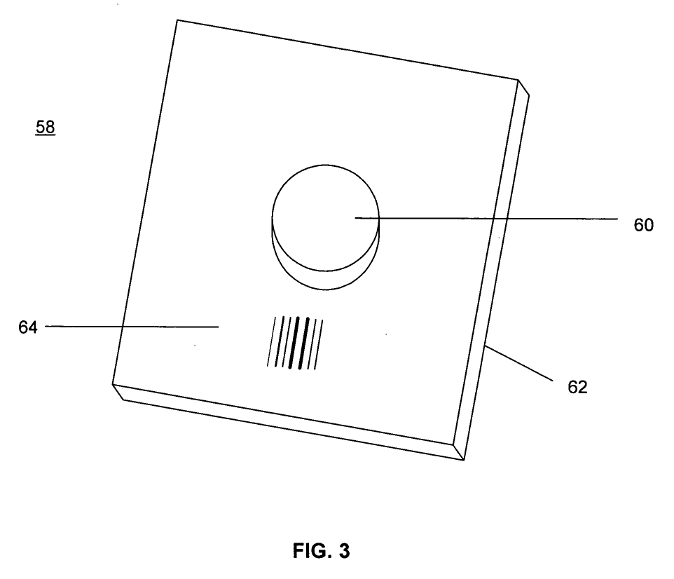

In the system as described thus far, the transmitter 26 and the information button 24 are separate items and may be applied to an item 22 at different times. FIG. 2 is a perspective view of an electronic device 58 which incorporates the functionality of a location transmitter and an information button into a single unit. Such incorporation provides advantageous additional functionality, as will be further described. Electronic device 58 includes an information button 60 that is mounted on a patch electronic circuit package 62, and which can be attached to a package or other item by self-stick adhesive or using tape. Advantageously the package 62 may include a bar code 64 which can be scanned to obtain data concerning the identification of device 58, and its radio identity.

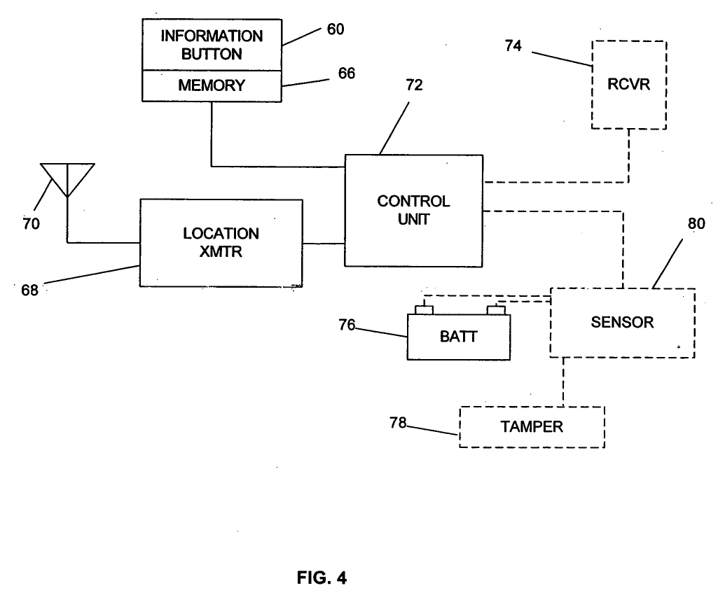

FIG. 3 is a block diagram showing the arrangement of components according to an exemplary embodiment of the electronic device of FIG. 2. Information button 60 includes a memory 66 for storing data concerning an item to which the electronic device 58 is attached. A location transmitter 68, having an antenna 70 is provided. As discussed above transmitter 68 may be a passive or semi-passive RFID tag or an IEEE Standard 802.11 transmitter. A control unit 72, which may be a simple processor may be provided interconnecting the information button memory 66 with the transmitter 68. Alternately, the control unit may be part of the information button circuit. According to the functionality required, the control unit may not be connected to the information button.

In one arrangement the control unit may be arranged to receive data from the information button indicating that there has been a contact read, or write, to the information button. This data may also identify the device that interfaced with the information button. This data can then be sent by transmitter 68, alone or in connection with its location signal, to the computer 12 via the WLAN for keeping a log of access to the information button data.

In another arrangement the control unit may be arranged to transfer selected data, such as data identifying the contents of a package to the computer. Since the information button 60 can store a significant amount of data, and the location transmitter has a limited capacity for sending data, the data may be transferred a portion at a time with each location transmission. The data can be transmitted in a cyclic fashion over a period of time. Alternately, the data may only be transmitted upon request, such as a special code used in RFID interrogation where the transmitter is an RFID tag, or by receiving an special signal on a receiver 74, which is optionally provided for that function. Receiver 74 may also be an RFID device.

In addition, or instead of, to transmitting data concerning operation of the information button, electronic device 58 may have monitoring functions. One example is to provide a sensor 80 to sense the impending failure of a battery 76 in the unit. Another example is that there may be provided a tamper device which provides an indication to sensor 80 when the electronic device is removed from a package or item or otherwise disturbed.

In another exemplary embodiment of the present invention, a typical RFID tag may be improved to include information button capability—i.e., the RFID tag information may alternatively be derived by employing contact read capability. An RFID tag device with such a configuration would provide benefits in terms of data redundancy. Normally, should an RFID tag antenna become damaged, or the battery become depleted to the point that the tag is inoperable, the information stored in the RFID tag memory can no longer be read. A contact read configuration may be employed on the RFID tag to provide a backup or alternative means for reading data from the RFID tag memory.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. An electronic device for locating and identifying an item, comprising:
an information button having a memory arranged to receive and store data, said data including data identifying an item to which said electronic device is attached, said information button being arranged to provide said data to a contact reading device;
an identifying location system transmitter arranged to transmit signals identifying said transmitter for use in locating said item to which said electronic device is attached using a location system, and to selectively transmit additional data; and
a control unit arranged to selectively transfer data to said identifying location system transmitter and to cause said transmitter to transmit said transferred data.

2. An electronic device as specified in claim 1 wherein said control unit is arranged to selectively transfer data representing an exception event for said information button.

3. An electronic device as specified in claim 1 wherein said control unit is arranged to selectively transfer data representing an event of reading data from said information button.

4. An electronic device as specified in claim 1 wherein said control unit is arranged to selectively transfer data representing an event of writing data to said information button.

5. An electronic device as specified in claim 1 wherein said control unit is arranged to selectively transfer data representing an event of tampering with said electronic device.

6. An electronic device as specified in claim 1 wherein said control unit is arranged to selectively transfer data representing a failing battery.

7. An electronic device as specified in claim 1 wherein said control unit is arranged to selectively transfer selected data stored in said information button memory.

8. A method for providing information concerning an item, comprising;
providing an information button on said item, said information button containing data identifying said item;
providing an identifying location system transmitter on said item;
reading said information button and storing said data identifying said item in a computer associated with data identifying said location system transmitter;
using a location system to locate said item by transmissions from said identifying location system transmitter; and
retrieving said data identifying said item from said computer using said location system transmitter identifying data.

9. A method as specified in claim 8 wherein said providing a location transmitter comprises providing a location transmitter having said data identifying said location system transmitter as a bar code on said transmitter and wherein said bar code is read to obtain said location system transmitter identifying data.

10. A method for verifying the identity of a device in an RF environment, comprising;
providing an information button on said device, said information button containing data identifying said device;
providing an RF transmitter in said device;
receiving RF signals from said transmitter; and
reading from said information button said data identifying said device to verify the identity of the device.

11. A method for providing information concerning location of an item, comprising;
providing an information button on said item, said information button containing data identifying said item;
providing an identifying location system transmitter on said item;
reading said information button and storing said data identifying said item in a computer associated with data identifying said location system transmitter;
using a location system to locate said item and storing data representing location of said item in said computer; and
retrieving said data representing location of said item from said computer by comparing data representing a desired item with said stored data identifying said item.

12. A method for monitoring an information button device, comprising:
providing a monitoring computer connected to receive data from a location system;
providing an information button having an identifying location system transmitter; and
using said location system transmitter to signal said monitoring computer that an exception event has occurred for said information button.

13. A method as specified in claim 12 wherein said location system transmitter signals said monitoring computer when said information button is read.

14. A method as specified in claim 12 wherein said location system transmitter signals said monitoring computer when said information button is written to.

15. A method as specified in claim 12 wherein said location system transmitter signals said monitoring computer when a battery powering one of said location system transmitter and said information button is failing.

16. A method as specified in claim 12 wherein said location system transmitter signals said monitoring computer when said information button is tampered with.

17. A method for transferring data from an information button device to a computer, comprising:
providing a location system transmitter connected to receive data stored in a memory of said information button, and arranged to communicate with a location system having a computer; and
transferring selected data from said information button memory to said transmitter and transmitting said data to said computer.

18. A method as specified in claim 17 wherein said data is periodically transferred to said transmitter in cyclical increments.

19. A method as specified in claim 17 wherein there is further provided a receiver for receiving command signals and wherein said selected data is transferred to said transmitter in response to said command signals.

20. An RFID tag device comprising a memory and further comprising information button capability, wherein data stored in said memory can be read from the RFID tag device by a reading device using at least one of RF signals or contact reading.
